(19) United States
(12) Patent Application Publication
(10) Pub. No.: US 2022/0406114 A1
(43) Pub. Date: Dec. 22, 2022

(54) CRYPTOGRAPHICALLY SECURED PAPER BALLOT VOTING SYSTEM

(71) Applicant: MatterFi, Sheridan, WY (US)

(72) Inventor: Michal Pospieszalski, West Hollywood, CA (US)

(73) Assignee: MatterFi, Sheridan, WY (US)

(21) Appl. No.: 17/668,368

(22) Filed: Feb. 9, 2022

Related U.S. Application Data
(60) Provisional application No. 63/147,717, filed on Feb. 9, 2021.

(51) Int. Cl. G07C 13/00; G06K 1/12

(52) U.S. Cl. CPC G07C 13/00; G06K 1/121; G06Q 2230/00

(57) ABSTRACT

A cryptographically secured voting process that includes applying a blinding process on a voting serial number during registration to hide the vote serial number from a registration authority so there is no way for the registration authority to associate the voting serial number with an identity credential of a voter. The voting process may include applying to a ballot an encrypted voting ticket identifier where the ballot has vote selections, y, and the encrypted voting ticket identifier is s′(x), where, x is a voting ticket id, and function s′( ) is private signer function of an election authority. The voting ticket identifier may be randomly generated. The voting process furthermore including: applying to the ballot an error check hash of the vote selections and the encrypted voting ticket identifier where the error check hash=h(y+s′(x)), where y+s′(x) is a concatenation of y and s′(x).

### FIELD OF THE INVENTION

Election voting machines and process more particularly cryptographic security of election votes and tabulation.

### BACKGROUND OF THE INVENTION

Although the security of electronic voting has been suspect since at least 2006, in 2020 the concern and perception of voter fraud has substantially increased. This is in part due to the increase of mail in paper ballots that took an existing system that was already stressed and made it far worse. The paper ballots made a number of attack paths easier including voter manufacturing, signature verification tampering, adjudication system manipulation, vote tabulation manipulation, repeat ballot rescanning, and ballot counterfeiting to name some.

Voter manufacturing is where the attackers control the voting system registering voter data and are able to check off voters as having voted, as well as creating “new” voters. This attack allows an attacker to print and submit a false ballots to the tabulation system, causing the vote total and the registration total to increase and stay matched due to the fabricated votes.

Signature verification tampering is when the signature verification system is weakened or disabled, thus allowing fraudulent mail-in ballots to be counted as real.

Adjudication system manipulation is when adjudication systems (meant to be invoked when a ballot fails to read, so a person/persons can adjudicate the markings on the ballot) are misused and abused to modify votes. Without changing a ballot, an electronic scanner can be instructed to believe that a ballot is defective and subsequently to be ruled on by a human. Mass adjudication with little or no logging can result in a few persons deciding thousands of votes, which if done fraudulently disenfranchises voters.

Vote tabulation manipulation is when ballot scanners and precinct, district, or tabulators changing totals. Often the existing tabulation process relies on tiles being copied via pen drive (USB stick) from the scanner machines to the tabulator machines. This is vulnerable to human error and manipulation. For example, votes can be effectively deleted by not delivering the USB stick or deleting the media on the USB stick with no checksum available on either side for chain-of-custody. The computers used for central tabulation also often use commercial-off-the-shelf (COTS) software and hardware that makes the software vulnerable to hacking.

Repeat ballot rescanning can occur since ballots are not serialized, thus the same ballot can be rescanned multiple times and the scanner will continue to count it as valid. If there is no envelope recount, then a hackers may access the voter registration system and simply mark new voters that haven't yet voted as having voted to match the number of rescans made.

Ballot counterfeiting can occur because for a ballot to be counted it must only be good enough to scan successfully. Therefore, it's inappropriately easy to make new ballots and populate them. This is possible because there is no ballot serialization in any existing voting system. One could also order extra ballots or use ballots from storage and inject them into the tabulation process.

Although numerous new digital voting approaches have been proposed over the last few decades by notable cryptographers such as David Chaum none of these approaches were designed to work with existing municipal systems. Additionally, numerous experts have suggested voting “on the blockchain” however, on-chain voting has numerous drawbacks such as delayed tabulation and mining fees.

What is needed is a system that provides secure ‘one voter, one vote’ tabulation system that is not so reliant of people since people make mistakes.

To minimize adjudication, ballot adjudication should be a tightly controlled and rare process. There should be little to no possibility of a paper ballot being machine un-readable.

Risk reduction towards registration is important. Every jurisdiction in the US has its own voter registration requirements. Voter registration should be as secure as possible to narrowly meet the latter requirements while at the same time not disenfranchising voters. Once a voter is issued a ballot, there should be by design little or no security concerns as to the integrity of the vote.

A desirable characteristic of the solution is ballot problem alerting. If there is a problem with the ballot it would be good to alert to voter that their ballot was not-counted, if a voter's ballot wasn't counted the voter should be notified.

Ballot anonymity, a ballot should be blinded (made anonymous) once the ballot is issued to the registered voter. Once a voter casts a ballot it must not reveal the identity of the voter.

Vote replay and vote notification, a notification with a trace-link should be available to the voter when their vote is counted and replay of how they cast their ballot (only re-playable by the voter). Note that Involuntary Privacy is an optional requirement of the system. Involuntary Privacy means a voter can't prove to a 3rd party how they voted. It is inure important for the voter to prove to themselves, and election authorities, how they voted.

Existing systems retrofit, the solution ideally should be able to work with existing voting systems with software upgrades and minimal additional hardware.

FIG. 1 illustrates an example of a traditional in-person voting data flow l00 consisting of four steps.

Before actual voting takes place there is a voter registration step which, in most jurisdictions, coincides with USPS (United States Postal Service) changes of address or driver's license changes of address. Each jurisdiction maintains a registered voter registration database 102 according to the requirements of the jurisdiction. Before an election takes place, the voting equipment is configured with an “election definition” to correctly display the election choices. Each jurisdiction generally has its own “election definition.” The election definition contains the list of offices, candidates for each office, and other information like party affiliation if required.

First a voter 104 arrives at a polling location and provides identification such as a driver's license. The poll workers 106 take the identification and verify the voter 104, for example by looking up the voter in the registered voter database 102. The voter 104 may then be presented with an authentication voting token 108, for example a smart card that the voter can physically walk over to the Direct-Recording Electronic (DRE) Voting Machine 110.

Second, the voter 104 may insert the authentication voting token 108 into the DRE voting machine 110 and vote. The DRE voting machine 110 may then print the voter's ballot 112 or print the vote to a roll of paper that the voter can see so the voter can verify that the DRE voting machine 110 correctly captured their vote. The authentication voting token 108 may electronically contains the election definition such that the ORE voting machine 110 can correctly display the voter's choices.

Third, when the polling location closes, the voted ballots may then either be tabulated electronically (retaining the DRE printed ballots as a paper backup) or the DRE printed ballots may be scanned via a ballot scanner 114. If the ballot scanner 114 can't read a ballot the ballot image may be saved, and that ballot may go into the adjudication process where human operators may try to discern the meaning and intent of the ballot.

Fourth and finally, the vote totals 116 are sent to a central precinct. Once the vote totals arrive at a central precinct they are summed by a vote tabulation system. This data transfer typically takes place via portable memory devices like commercial-off-the-shelf (COTS) Compact Flash (CE) or USB sticks. The memory devices may be physically driven from the polling location to the central precinct location. The portable memory device may be conventionally formatted although the voting data on them may be encrypted with symmetric encryption.

Finally, the precinct reports its results to the state for certification.

FIG. 2A and 2B depicts a commercially available ExpressVote® DRE Voting Machine 110A.

FIG. 3 illustrates a commercially available ballot scanner 114A.

FIG. 4 illustrates and example of a traditional mail-in ballot data flow 400

As with the in-person voting the voter registration process precedes the vote and is generally the same for mail-in voting and in-person voting.

The traditional mail-in ballot data flow 400 and tabulation itself consist of five steps:

First, mail in voters 404 are sent a mail-in ballot 406 and a ballot envelope 408, Sometimes, like in the 2020 federal election, all voters in the registered voter database 102 may be considered mail in voters 404, The mail-in ballot 406 may consist of human-readable election choices and a digitally readable election definition typically encoded with a ‘QR Code’ The mail in ballot 406 may be put in the ballot envelope 408 may be returned via the USPS mail or by dropping the ballot envelop 408 in a ballot drop box. The ballot envelope 408 may consists of an area for signature verification and also contains the voter identification information.

Second, the mail in voter 404 votes on the mail-in ballot 406 typically by marking with a pen checkboxes or bubble boxes. Then the voter 404 signs the ballot envelope 408.

Third, the mail in voter 404 places the voted mail in ballot 406A in the signed ballot envelope 408A and returns the signed ballot envelope 408A, for example dropping the signed ballot envelope 408A at an election dropbox or placing it in a USPS mail box.

When the voted mail in ballot 406A and signed ballot envelope 408B arrive at a tabulation location, the poll workers 410 verify the voter's eligibility, typically comparing the signature on the envelope with the voter's on-record signature in the registered voter database 102. If the signature verification matches the mail in ballot 406B is removed from the ballot envelope 408C and the now anonymous voted mail in ballot 406C is sent to the ballot scanner 114.

Ballots scanners 114 are used in the same manner as they are during in-person voting including adjudication but lacking the voter's presence to resolve any problems with their ballot adjudication may be more likely.

Finally, the vote totals 116 arrive at a central precinct location where they are summed by a vote tabulation system. This data transfer typically takes place via USB cards that are physically driven from the location from step ‘4’ to step ‘5’.

At the end of this process, the precinct reports its results to the state for certification.

FIG. 5 illustrates a portion of a mail-in ballot 406C with digitally readable election definition encoded with a ‘QR Code’ 502.

FIG. 6 illustrates a portion of a ballot envelope 408C with an area for signature verification 602.

FIG. 7 illustrates a portion of a ballot envelope 408D with voter identification information 702.

What is needed is a voting system, or a retrofit enhancement to existing voting systems that can provide enhancement to ensure “one voter, one vote”, minimize adjudication, secure registration, provide not counting alert, ballot amenity, voter vote replay/notification.

### SUMMARY OF THE INVENTION

The present disclosure describes a Cryptographically secured electronic voting process that includes applying a blinding process on a voting serial number during registration to hide the vote serial number from a registration authority so there is no way for the registration authority to associate the voting serial number with an identity credential of a voter.

The voting process may include applying to a ballot an encrypted voting ticket identifier where the ballot has vote selections, y, and the encrypted voting ticket identifier is s′(x), where, x is a voting ticket id, and function s′( ) is a private signer function of an election authority.

The voting ticket identifier may be randomly generated.

The voting process furthermore including: applying to the ballot an error check hash of the vote selections and the encrypted voting ticket identifier where the error check hash =h(y+s′(x)), where y+s′(x) is a concatenation of y and s′(x).

The voting process where the error checking hash is provided by a voter app. The voting process where the ballot is a physical ballot and the applying to the ballot is printing on the ballot a QR code. The voting process where the ballot is recorded on direct-recording electronic (DRE) and the applying is adding to the DRE record.

The voting process also includes applying a voting ticket, and a ballot integrity code, to a ballot, and providing to a voter a voter receipt where: the voting ticket is s′(x), where: x is a voting ticket id function s′( ) is private signing function of an election authority. The process also includes the ballot integrity code is vs′(h(y+s′(x))) where: y is the vote selections of the voter. The process also includes where y+s′(x) is a concatenation of y and s′(x) is the voting ticket function h() is a hash function. Function vs′( ) is voter private signing key function. The process also includes a voter receipt with cryptographic details that enables the voter to expose the vote selections y in the ballot integrity code.

The voting process where: the voter receipt includes a public key corresponding to a private key used in the function vs′( ).

Receiving a ballot with a encrypted voting ticket identifier and a vote tally where: the encrypted voting ticket identifier is s′(x), with x being a voting ticket id, and s′( ) being a function that is private signer function of an election authority, and the vote y. The process also includes processing the ballots on a cryptographically secured voting tabulation system.

The voting process where the cryptographically secured voting tabulation system includes a notary server running, and the notary server processes the vote ticketing by reducing an issued vote currency balance and correspondingly increasing a candidate account. The voting process where the secured voting tabulation system includes a pool of notary servers. The voting process where the pool of notary servers includes an election authority notary server and a political party notary server. The voting process where the political party notary server is a republican party notary server and the pool of notary servers incudes a democratic party notary server. The voting process where the secure voting tabulation system includes a blockchain. The voting process where, the secure voting tabulation system includes a smart contract

### BRIEF DESCRIPTION OF THE DRAWINGS

FIG. 1 illustrates an example of traditional in-person voting data flow.

FIGS. 2A and 2B depict a Direct Recording Electronic (DRE) Voting Machine.

FIG. 3 illustrates a ballot scanner.

FIG. 4 illustrates an example of a traditional mail in voting data flow.

FIG. 5 illustrates a portion of a mail-in ballot with election definition ‘QR Code’.

FIG. 6 illustrates a portion of a ballots envelope with an area for signature verification.

FIG. 7 illustrates a portion of a ballot envelope with voter identification information.

FIG. 8 illustrates an example of a cryptographically secured in person voting data flow.

FIG. 9 illustrates an example of a cryptographically secured mail in voting data flow.

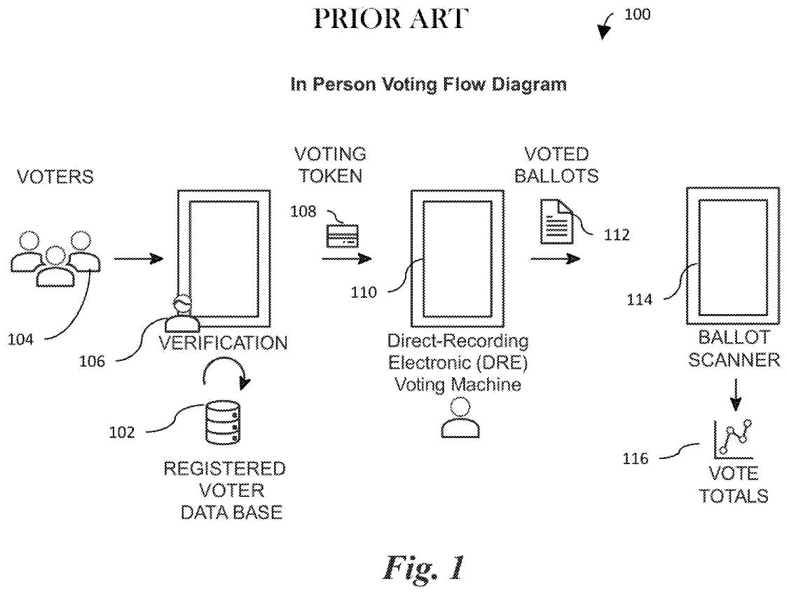

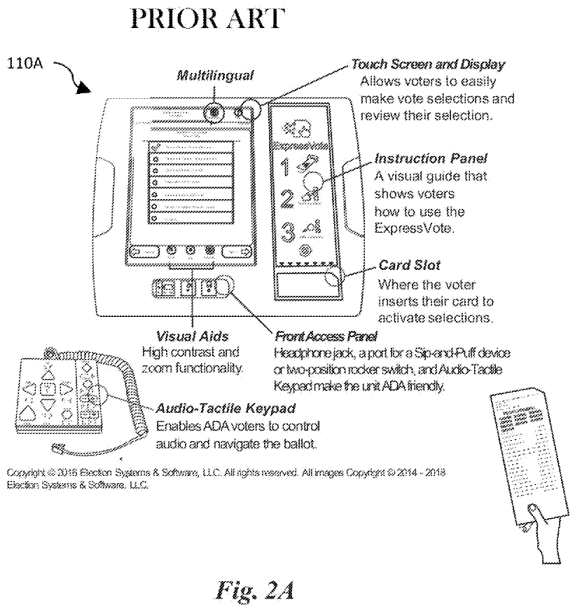

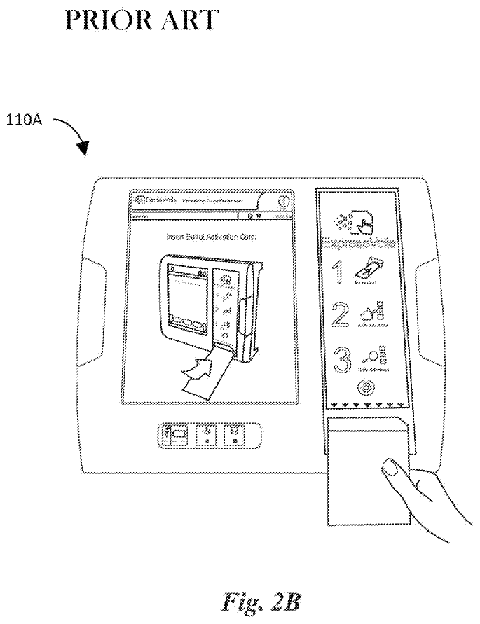

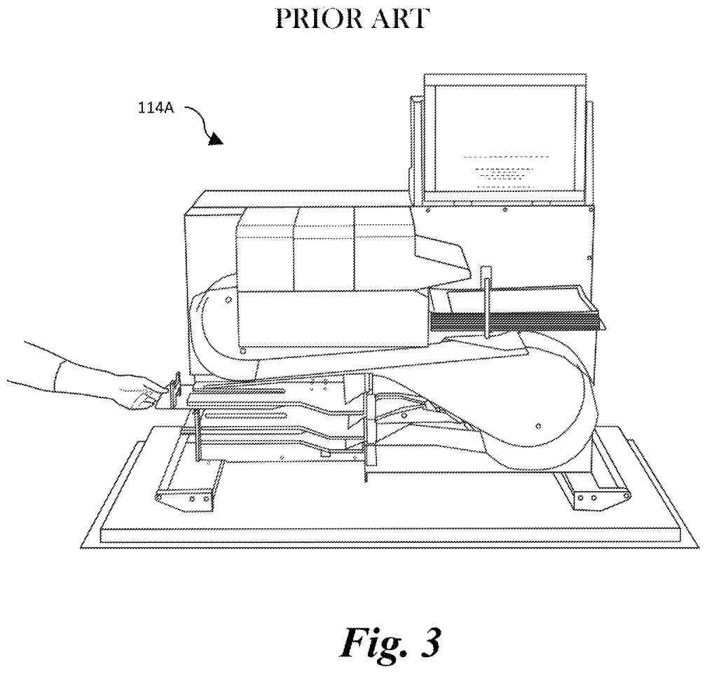

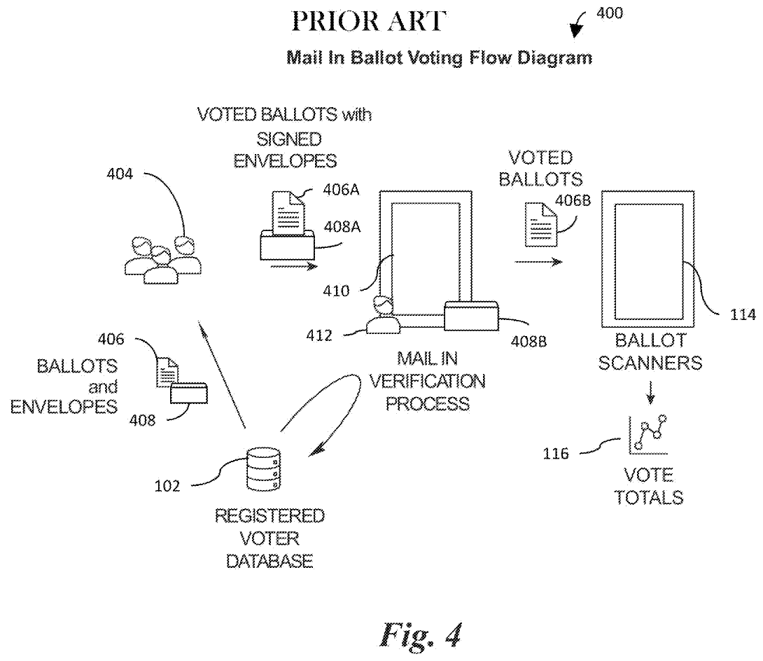

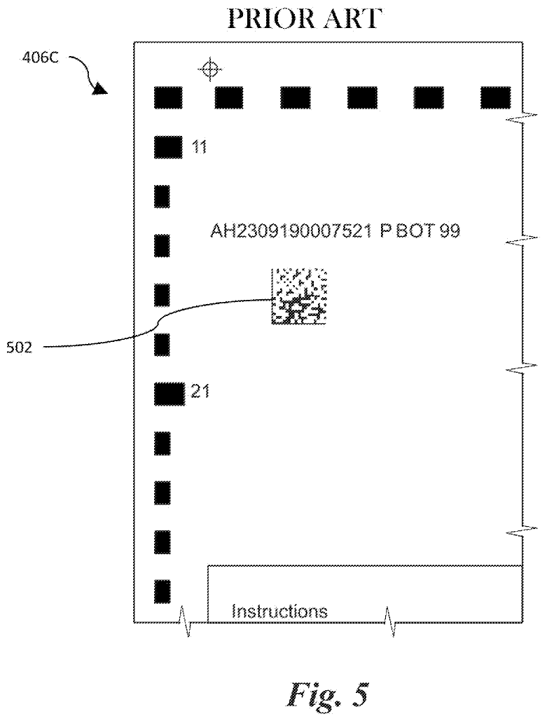

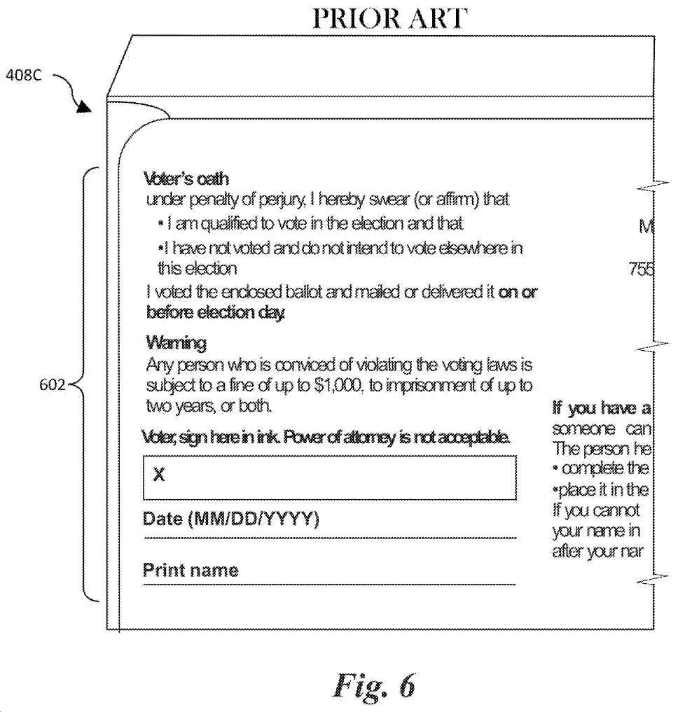

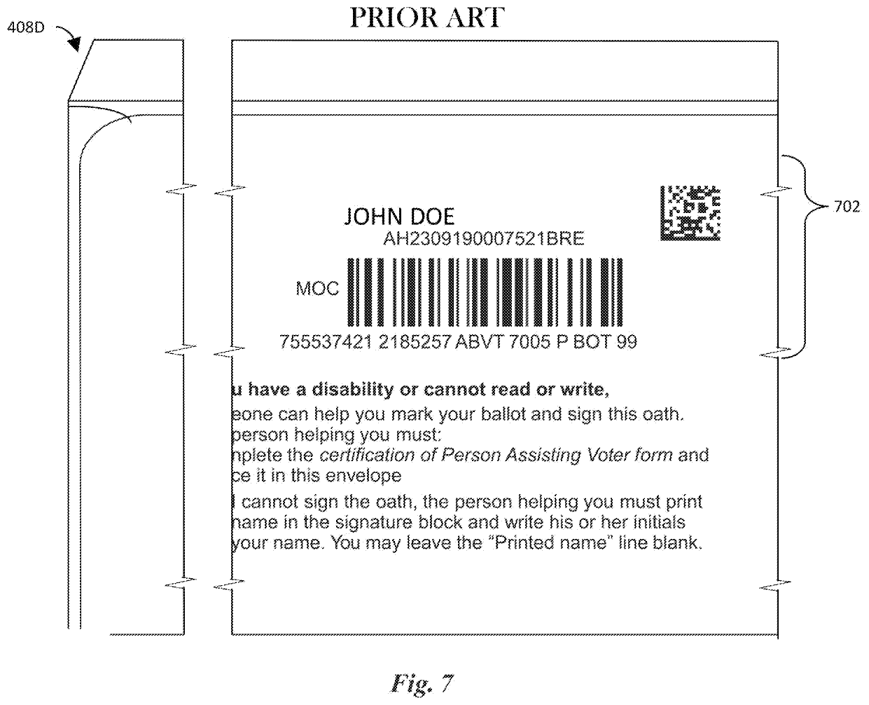

### DETAILED DESCRIPTION

The mathematic principals for a cryptographically secured electronic voting system doesn't need blockchain technology to have end-to-end (E2E) integrity of the vote, a system just needs to have E2E cryptographic proofs including a tabulation system that uses cryptographic proofs.

This document proposes a retrofit scheme for electronic voting that can use cryptographic proof servers called notary servers. The retrofit scheme may further assume that the existing system is untrusted and create a new scheme where the E2E integrity of the vote is maintained through cryptography even though the ballots will travel through a potentially insecure system.

The cryptographically secured voting system may use blind signing of a vote serial number, to enable anonymity of the vote. The blind signed vote serial number offers cryptographic proof of the ballot being valid. The cryptographic proof may be used at any point in the process to validate ballot including tabulation and even through recount.

One way the cryptographically secured voting system may implement the blind signing is an extension of the Chaumian blind signing.

Chaumian Blinding was originally presented in 1982 by David Chaum. Chaumian Blinding allows for a digital equivalent of an anonymous paper ballot. It allows for the process of computer vote tabulation from anonymous digital ballots and knowing—via cryptographic proof—that a ballot is valid.

David Chaum's original paper provided an analogy of how Chaumian Blinding may be used in an election:

A solution can be obtained by use of . . . special envelopes. Each elector places a ballot slip with their vote written on it in a carbon lined envelope; places the carbon lined envelope in an outer envelope addressed to the trustee, with their own return address; and mails the nested envelopes to the trustee. When the trustee receives an outer envelope with the return address of an elector on it, the trustee removes the inner carbon lined envelope from the outer envelope; signs the outside of the carbon lined envelope, and then returns it to the return address from the old outer envelope. Thus, only authorized electors receive signed ballot slips. Of course, the trustee uses a special signature which is only valid for the election!

“When an elector receives a signed envelope, the elector removes the outer envelope; checks the signature on the carbon lined envelope; removes the signed ballot slip from the carbon lined envelope; and mails the ballot to the trustee on the day of the election in a new outer envelope, without a return address.

“When the trustee receives the ballots, they can be put on public display. Anyone can count the displayed ballots and check the signatures on them. If electors remember some identifying aspect of their ballot, such as the fiber pattern of the paper, they can cheek that their ballot is on display. But since the trustee never actually saw the ballot slips while signing them (and assuming every signature is identical), the trustee cannot know any identifying aspect of the ballot slips. Therefore, the trustee cannot know anything about the correspondence between the ballot containing envelopes signed and the ballots made public. Thus, the trustee cannot determine how anyone voted.”

The above concepts were patented using Rivest, Shamir, and Alderman's (RSA) Digital Signature scheme in 1988. Some alternative implement Mons of blinding have been developed since, including Elliptic Curve (EC) digital signatures and Digital Signature Algorithm (DSA)/Lucre by Ben Laurie which may be used by the cryptographically secured voting system.

In general, the blind signature may use a publicly available digital signature schemes such that:
1) A signing function s′( ) is known only to the signer, and the corresponding inverse function s( ) is known to the public, such that s(s′(x))=x and s( ) give no clue about s′( ).
2) A commuting function c( ) and its inverse c′( ), both known only to the voter, such that c′(s′(c(x)))=s′(x), and c( )and s′( ) give no clue about x.
3) A redundancy checking predicate r, that checks for sufficient redundancy to make the search for valid signatures impractical.

The cryptographically secured voting system may digitally implement anonymous ballots by blind signature. This approach allows that a signed ballot can be digitally stripped of its identifying information before submission to voting tabulation as described originally by Chaum.

The use of the blind signing algorithm is reminiscent of the way the carbon paper lined envelopes were used in the example described above. Specifically, the algorithm as described by Chaum had four steps as applied to a ballot voting system as follows:
1) A voter chooses or receives a ballot identifier, generated at random, such that the x passes the redundancy check r(x), performs a commuting function on x, c(x), and supplies the commuted (i.e. blinded) ballot identifier, c(x), to the cryptographically secured voting system.
2) The cryptographically secured voting system signs the blinded number, c(x), by applying signing method s′() and returning the signed blinded vote serial number s′(c(x)) to the voter.
3) The voter strips the blinding by reversing the commuting function by application of inverse of the commuting function c′( ), c′(s′(c(x))) thus yielding the signed ballot identifier s′(x) because by definition c′(s′(c(x)))=s′(x).
4) Anyone, may check that the signed ballot identifier s′(x) was formed by the cryptographically secured voting, system by applying the cryptographically secured voting system's public key s( ) to access to ballot identifier x, s(s′(x))=x, and one may also check that the resulting x passes the redundancy check r(x).

Thus, at step 4 anyone (for example a person in the general public or a representative of the losing candidate) can know that the ballot cast was a valid ballot without knowing who cast it.

This voting system may extend the original Chaumian blinding such that the cryptographically secured voting system can, be used to retrofit the blind signatures into the existing voting machines and processes to add extra desirable properties, for example giving the voter the ability to see their vote and make it so the system is unable to double count a vote.

The cryptographically secured voting system may use blind signatures to establish that a voter may cast a ballot. The blind signature may be used for serialization the thus the ballot may be anonymous. Due to the connectivity limitations of the retrofit, a blinded ballot cannot be voted on then blinded. To maintain compatibility with existing paper ballot legal regulations, in the system the completed ballot itself is plain text although it may be optionally be additionally secured in transit using session encryption. The cryptographically secured system may avoid a registration authority knowing how a voter voted, since the people working in the registration authority will no longer need to be trusted during the ballot issuing process, because they fail to have access to the vote serial number x and thus cannot associate the serial number x to the identity of the voter.

The cryptographically secured voting system may use the following algorithm expanded from the four-step version above.

The cryptographically secured voting system generates a randomly selected vote serial number.

Receipt and digital verification of the number calculated from s′(c(x)) in step 3 above allows the voter to Vote, and the voting system may at the same time provide a plain text (digital or paper ballot) containing a blinded vote serial number, for example, the private key encrypted blinded (e.g. commuted) vote serial number, s′(c(x)), as additional information, The voting system may issue s′(c(x)) only when a registration authority verifies the voter is an eligible voter, for example a registered voter. The system may verify a voter via a registration process, preferably a hardened registration process. One impact of using blinding of the vote serial number is that the vote serial number is hidden from the registration authority when the voter is providing their identity credentials.

Following step 3 the voter may vote and submit both a digital version and printed version of their ballot anonymously along with the vote serial number, x, and the signed vote serial number, s′(x), to the voting system. The signed vote serial number, s′(x), may be computed via c′(s′(c(x))) s′(x). When the voting system sees s′(x) the system knows that it should count this ballot. i.e. s′(x) along with x serves a serialized “ticket” which allows the voter to vote but doesn't reveal the identity of the voter. Each, voted ballot submitted with s′(x) shall only be counted once. As such s′(x) may serve as the ballot serialization identifier.

The voter may have a hash method, h( ). The voter has their vote selections, y, also known as a vote tally. For example, y may be the ballot selections represented as a big number. The voter may have the signed serialization s′(x). The voter may have a voter private signing key function, vs′( ).

The voter may sign the vote selection and signed serialization, y+s′(x). For example signing maybe performed by signing a hash of the selection and serialization, vs′(h(y+s′(x))). Also, the unsigned hash, h(y+s′(x)), may also be provided with the ballot. The unsigned hash itself, h(y+s′(x)), serves as a simple error checking mechanism. The cryptographically signed ballot, vs′(h(y+s′(x))), allows a voter to claim someone hijacked their ticket at the expense of revealing their identity. The cryptographically signed ballot, vs′(h(y+s′(x))), also prevents a voter from defrauding the system and changing their vote post-election. Since adjudication post-election in existing systems already necessitates revealing one's identity this seen as, a breach of privacy. In this scenario only the identity of voters who are disputing their results would be revealed to election officials.

The voting system may publish upon tabulation all the anonymous ballots and exactly how they were counted along with the corresponding vote serial number, x, (and the voting system private encrypted vote serial number, s′(x) (i.e. voting ticket)—which is the publicly verifiable authentication of a valid vote. And finally, the system my provide the cryptographically signed ballot, vs′(h(y+s′(x))), which is the privately verifiable and provable to an election authority of how an individual user voted using a particular vote serial number x.

The cryptographically secured voteing system private key encrypted vote serial number, s′(x), and cryptographical signed ballot, vs′(h(y+s′(x))), may be represented as QR codes and added to physically mailed ballots and printed on DREs.

The system may use the following terms:

Voting ticket is s′(x), also known as VT code, or the encrypted vote serial number.

Ballot integrity code is vs′(h(y+VT)) also known as the BI code, or cryptographically signed ballot.

Each voter may have a voting receipt (VR) that is unique one-time randomly generated by the voter app private/public key (hair along with x that allows the voter to verify their own ballot integrity code, BI code.

The system retrofit implementation may provide a cryptographically secure paper ballot.

The system may have a ballot that is identical in appearance to existing scannable and human-readable anonymous ballots but upon voter marking the cryptographically secure voting system (for example MatterVote™) attaches two cryptographic codes that are an blinded representation of the voter's choice that can be computed by a notary server or an on-chain “vote tabulation” contract-as well as traditionally scanned and counted. When the cryptographic code is attached to the voted ballot, the cryptographically secure system may also generate a receipt for the voter which is a key that can be used to verify the integrity of the voter's vote. These additional cryptographic codes may be represented as QR codes and the voter, therefore, may use the QR code on the receipt to verify their vote was counted using their smart device (e.g. smart phone tablet, computer). The voter can also verify their voting choices. Only the voter can verify their vote or prove to others how they voted; the system is otherwise completely anonymous.

The system be an add-on to existing voting system. The add-on may allow for the computation of a cryptographically ensured vote total. The ensured vote total can then be compared to the traditional tabulated vote total that comes from traditional methods.

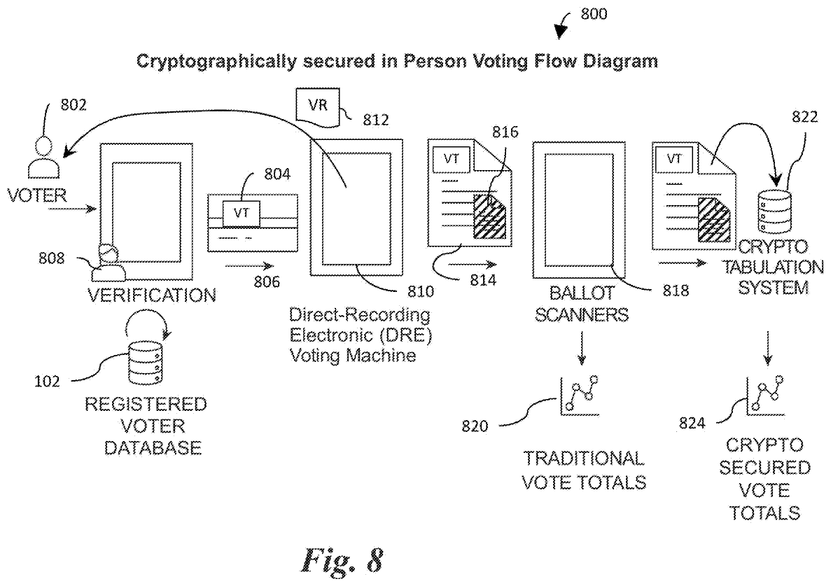

FIG. 8 illustrates, an example of a cryptographically secured in person voting data flow 800.

The in person voting data flow 800 begins with the voter 802 arrives to be verified. When the voter 802 is verified, the voter 802 may be issued a voting ticket code, VT code 804 (i.e, blinded ballot ID), on for example the voting card 806 or voting media (e.g. portable memory). A verification authority 808 would sign the vote serial voting number (ballot ID) to create a vote ticket code, VT code 804, with the tabulation server's private key. The private key signing may use a hardware wallet.

The DRE Voting Machine 810 may generate the voting receipt, VR 812, (which may be a one-time private/public key pair for the voter 802) and print the voting receipt, VR 812, for the voter 802 or allow the voter 802 to capture the voting receipt. VR 812, as a photo, for example on their phone. With the voting receipt, VR 812, generated the DRE Voting Machine 810 may then append both a ballot integrity code, BI code 816, and the voting ticket code, VT code 804, to the ballot, for example a printed anonymous voted ballot 814. The DRE Voting machine 810 may use the voting receipt, VR 812, to generate a ballot integrity code, BI code 816, and then the DRE Voting Machine 810 should delete the VR 812, for example remove it from its memory. The DRE Voting Machine 810 should remove the VR 812 from both volatile memory and non-volatile memory for example it should not be in permeant memory, like a hard drive. Only the voter 802 should have a copy of the voting receipt, VR 812.

Tabulation proceeds as traditionally done on a ballot scanner 818, generating traditional vote totals 820, and in addition the anonymous voted ballots 814 and their associated ballot integrity code and voting ticket code, BI code 816 and VT code 804, are also submitted to the cryptographically secure voting system tabulation server 822. The cryptographically secure voting system tabulation server 822 may be implemented on notary server running in a pool. The cryptographically secure voting system tabulation server 822 may be implemented on the notary server as a currency contract where every issued voting ticket subtracts one on the issued vote currency balance and a adds one in the “cash” account or outstanding ballot count. As results are tabulated the currency is redeemed so if all issued ballots are voted on, the “cash” balance for each server eventually ends up being zero and any positive balance means sonic ballots for issued voting tickets were not received by the system.

The cryptographically secure voting system tabulation server 822 may run on a pool of notary servers operated by representatives of both parties such that collusion and cheating are unlikely, and the system building trust and confidence in the results in the multiple political parties that are running notary servers in the multisig notary voting pool. See U.S. Provisional Application No. 63/140,270 for a description of how a multisig notary voting pool may be implemented. U.S. Provisional Application No. 63/140,270, (filed Jan. 22, 2020), is incorporated by reference for all purposes as if fully written in this document. The multisig voting pool helps eliminates theft and fraud.

The voter 802 may check if their vote was counted using a voter app provided by cryptographically secure voting system and their voter record, VR 812. If their vote wasn't counted or counted incorrectly the voter 802 may submit a complaint to the elections board and prove how their vote should hate been counted.

The result is a redundant count based entirely on cryptographic proofs where secure elections starts by ensuring that the identity verification, and issuance of the voting ticket code, VT code 804, is secure. The cryptographic secure voting, system makes ballot stuffing:, tabulation manipulation, resubmission of paper ballots, voting machine hacking, all of the attacks described in this paper either unfeasible or catchable or both. At the same time, this system may work alongside existing systems and generates a cryptographically proven count that can be used to verify the traditional paper and electronic count. A voter 802 does not have to know about any of the cryptography that is helping ensure the integrity of the election. Simply the Voter Receipt (VR 812) would allow them to check if their vote was counted as they intended.

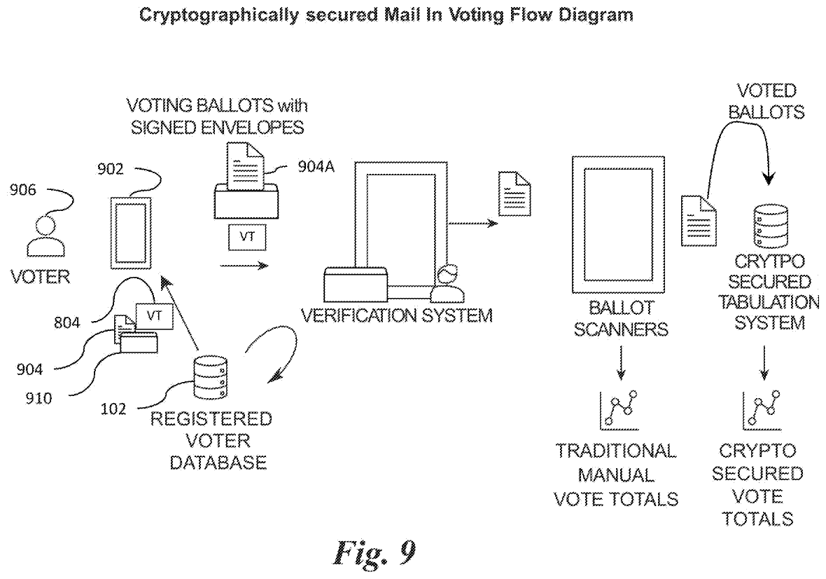

FIG. 9 illustrates an example of a cryptographically secured mail in voting data flow 900.

A voter app 902 (for example a phone app (e.g. iOS/android), tablet app or PC/website or URL) is used to issue mail in ballots 904 and voting ticket codes, VT code 804 (blinded Ballot ID). Registered voters 906 may receive a link to the voter app 902 that allows the voter 906 to submit a copy of their identification or whatever else a registration authority requires. The voter app 902 would then send the authentication data to the registration authority which would issue to the voter app 902 a voting ticket code, VT code 804.

Once the voter app 902 has a voting ticket code, VT code 804, then the voter 906 can vote. The system may provide a voting receipt, VR 812. The system may allow the voter to print out their anonymous ballot 904A with their also anonymous voting ticket code, VT code 804, and ballot integrity code, BI codes 816. Then the voter can submit the mail-in ballot via USPS and/or ballot drop boxes—however, the digital voted ballot may also be submitted digitally.

The cryptographic tabulation of the votes would use the same, system as described for in-person voting.

This system could work alongside a non-cryptographically enabled mail-in system. However, if this system was mandated mail-in ballot fraud would be extremely difficult. And the benefits of the system would proportionally increase with the amount of use. For example, it may be that if 80% of mail-in voting was done via voter app in this manner—then 80% of the risk would be eliminated.

The tabulation servers may treat each vote as a single unit of cryptocurrency that can only be used once disabling the chance of a vote being counted multiple times. Each voting ticket, VT Code 804, can only be used once, just like a bitcoin can only be spent once and this may be enforced with off-chain cryptographic proofs.

Adjudication of ballots should be minimized. Ballot adjudication should be a tightly controlled and rare process. There should be little to no possibility of a paper ballot being machine un-readable.

Because the system captures the actual vote digitally in both in-person and mail-in scenarios ballot reading confusion and therefore adjudication processing may be eliminated in the cryptographically secure Cryptographically secure voting system, There would still be adjudication happening in the traditional system however comparing the results between the two would make detecting fraud on the traditional side easier.

Risk Reduction Towards Registration, every' jurisdiction in the US has voter registration requirements. Voter registration should be as secure as possible to narrowly meet the latter requirements while at the same time not disenfranchising voters. Once a voter is issued a ballot, there should be little, or no security concerns as to the integrity of the vote by design.

The cryptographically secure voting system may only allow a voting ticket (VT code 804) to be issued when a registration authority signs. The system prefers that the signing process to be done with hardware wallets and full audit-ability. So, if extra, inappropriate anonymous ballots are issued the people would know who did it and when they did it.

The system may provide alerts to voters 906 for example, non-counted alerting, vote replay alert, and vote tabulation notification. If a voter's ballot wasn't counted the system may notify the voter.

The cryptographically secure voting system and voter app 902 provided to the voter may ingest the voting receipt (VR 812) and then be able to inform the voter 906 of how their vote was counted or wasn't counted. If the voter thinks that their vote was manipulated, they can contact an election authority for adjudication where they can cryptographically and irrefutably prove how they voted with their B1 code 816 and VR 812.

A ballot should remain anonymous and with the system cryptographically blinding the ballot once the ballot is issued to the registered voter, anonymity can be maintained. Once a voter 906 casts a ballot the system may not reveal the identity of the voter.

Voting Ticket and Ballot Integrity leave the voter completely anonymous. The voting receipt VR 812 may be a one-time randomly generated public/private key pair that only the voter 906 has access to.

Existing voting systems may be retrofitted to provide the cryptographically security voting system. The cryptographically secured system may work with existing voting systems with software upgrades and minimal additional hardware.

The cryptographically secured voting system may be implemented by adding minimal extra tabulation hardware. Otherwise, the retrofit may consist of exclusively software changes. On the voting ticket VT code 804 issuance (voter registration) side it may be best to add extra security features (hardware wallets for VT code 804 signing) that jurisdictions could enable or disable.

The system may provide redundant tabulation with tabulation in this system that may be performed by notary servers, by an on-chain smart cryptocurrency contract, and via the traditional path. As such the electorate will have a high degree of confidence in the outcome and differences in the digital count vs the traditional count will be an objective measure of the accuracy of the traditional path.

This system may allow for traditional paper recounts. Since the voting ticket and the ballot integrity code, VT code 804 and BI code 816, are only appended to traditional ballots a traditional paper recount is possible. The traditional system may be enhanced to reject duplicate voting ticket, VT codes, thus eliminating a possible ballot injection attack path.

Due to the retrofit nature of this system, the system has potential exploits that are disclose here alongside their mitigations.

A first potential exploit and mitigation is regarding voter ticket, VT code, replay attacks, An attacker may digitally steal voting tickets, VT codes 804, before a voter votes and then effectively hijack the vote. However, should that happen, the mail in voter 906 will know as their VR code 812 will reveal to them the hijack if and only if the attacker voted in a different way than the voter. Furthermore, stealing VT codes en masse would require a massive hacking undertaking that can be guarded against with traditional software security and it is likely to be caught so this isn't a viable attack path for an attacker.

A second potential exploit and mitigation is regarding voter ticket, VT code 804 inflation. It is possible that an attacker could collude with a tabulation server to artificially print and vote with extra voter tickets, VT codes 804. This inflation attack is identical to off-chain cryptocurrency inflation attacks and may be mitigated by using hardware chips inside of voting pools. To successfully execute a voter ticket, VT code 804, inflation attack, an attacker would need to take over a majority of the tabulation pool, or a majority of the tabulation pool would have to collude in order to carry out an voter ticket inflation attack. Since the notary server tabulation pools are, by design, intended to be operated by opposing parties this attack is infeasible. For example, in a tabulation pool of 7 servers set to a supermajority of 5, five would have to be compromised by an attacker or collude. To compromise 5 servers an attacker would have to break into 5 of the servers, and if those severs have hardware wallets then it would be even more difficult to compromise the computation chips on each server's hardware wallet. See U.S. Provisional Application No. 63/140,270 for an in-depth discussion of pool implementations.

A tabulation pool and a notary server pool may be the same.

A third potential exploit and mitigation is regarding voting record code, VR 812, Theft. If an attacker steals a voting record code, VR 812, from a voter 906 either digitally or by simply getting a visual copy of the voting record QR code (VR 812), then the attacker can know how that particular voter 906 voted. However, stealing voting record code, VR 812, can't change the outcome of an election. Additionally, attackers would have to go hack the phones of each voter or the DREs that voters are using.

A fourth potential exploit and mitigation is regarding insufficient entropy. The system like almost all cryptosystems relies on good sources of entropy so one-time random seeds and key pairs are difficult to guess. Weak entropy sources would break the system. However, there are plentiful entropy sources available in DREs, phones and computers so weak entropy-based attacks are not likely to be viable.

With regard to the processes, systems, methods, heuristics, etc. described in this document, it should be understood that, although the document describes the steps of such processes, etc. as occurring in a certain sequence, in practice the processes might follow a different sequence. Further, although the system 100 may have described certain steps performed simultaneously, other steps may be added, or that certain steps described may be omitted. In other words, the descriptions of processes provided are for illustrating certain embodiments, and in no way limit the claims.

Accordingly, it is to be understood that the above description is intended to be illustrative and not restrictive. Mans embodiments and applications other than the examples provided would be apparent upon reading the above description. The scope should not be determined with reference to the above description, but should instead be determined with reference to the appended claims, along with the full scope of equivalents to which such claims are entitled. It is anticipated and intended that future developments will occur in the technologies discussed in this document, and that the disclosed systems and methods will incorporate such future developments. In sum, it should be understood that the application is capable of modification and variation.

All terms used in the claims are intended to be given their broadest reasonable constructions and their ordinary meanings as understood by those knowledgeable in the technologies described unless there is an explicit indication to the contrary in this document. In particular, use of the singular articles such as “a,” “the,” “said,” etc. should be read to recite one or more of the indicated elements unless a claim recites an explicit limitation to the contrary.

The Abstract attic Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features arc grouped together in various embodiments for the purpose of streamlining the disclosure. This method of disclosure is not to be interpreted as reflecting an intention that the claimed embodiments require more features than are expressly recited in each claim. Rather, the following claims reflect inventive subject matter with less than all features of a single disclosed embodiment. The following claims are hereby incorporated into the Detailed Description, with each claim standing on its own as separately claimed subject matter.

What is claimed is:

1. A voting process comprising:
applying a blinding process on a voting serial number during registration to hide the vote serial number from a registration authority, so there is no way for the registration authority to associate the voting serial number with an identity credential of a voter.

2. A voting process comprising:
applying to a ballot an encrypted voting ticket identifier where:
the ballot has a vote selections, y, and
the encrypted voting ticket identifier is s′(x),
where:
x is a voting ticket ID
function s′( ) is a private signer function of an election authority.

3. The voting process, of claim 2 where x is randomly generated.

4. The voting process of claim 2 furthermore including:
applying to the ballot an error check hash of the vote selections and the encrypted voting ticket identifier where the error check hash=h(y+s′(x)), where y+s′(x) is a concatenation of y and s′(x)

5. The voting process of claim 4 where the error checking hash is provided by a voter app.

6. A voting process comprising:
applying a voting ticket, and a ballot integrity code, to a ballot, and
providing to a voter a voter receipt where:
the voting ticket is s′(x),
where:
x is a voting ticket ID
function s′( ) is private signing function of an election authority,
the ballot integrity code is vs′(h(y+s′(x)))
where:
y is the vote selections of the voter,
where y+s′(x) is a concatenation of y and s′(x)
s′(x) is the voting ticket,
function h() is a hash function
function vs′( )is voter private signing key function,
the voter receipt includes cryptographic details that enables the voter to confirm the vote selections y in the ballot integrity code.

7. The voting process of claim 6 where:
the voter receipt includes a public key corresponding to a private key used in the function vs′( ).

8. The voting process of claim 2 where the ballot is a physical ballot and the applying is printing on the ballot as QR codes.

9. The voting process of claim 2 where the ballot is recorded on Direct-Recording, Electronic (DRE) and the applying is adding the DRE record.

10. A voting process comprising:
receiving a ballot with a encrypted voting ticket identifier and a vote tally where:
the encrypted voting ticket identifier is s′(x), with being a voting ticket ID, and s′( ) being a function that is private signer function of an election authority, and
the vote tally is y
processing the ballots on a cryptographically secured voting tabulation system.

11. The voting process of claim 10 where the cryptographically secured voting tabulation system includes a notary server running, and the notary server processes the vote ticketing by reducing an issued vote currency balance and correspondingly increasing a candidate account.

12. The voting process of claim 11 where the secured voting tabulation system includes a pool of notary servers.

13. The voting process of claim 12 where the pool of notary servers includes an election authority notary server and a political party notary server.

14. The voting process of claim 13 where the political party notary server is a Republican Party notary server and the pool of notary servers incudes a Democratic Party notary server.

15. The voting process of claim 10 where the secure voting tabulation system includes a blockchain.

16. The voting process of claim 15 where the secure voting tabulation, system includes a smart contract

17. The voting process of claim 15 where the secure voting tabulation system includes a notary server.
